(19) United States
(12) Patent Application Publication
(10) Pub. No.: US 2005/0230930 A1
(43) Pub. Date: Oct. 20, 2005

(54) Scooter

(76) Inventor: Charles Chung, Taipei Hsien (TW)

Correspondence Address: Charles Chung, 235 Chung-Ho, Box 8-24, Taipei, TW

(21) Appl. No.: 10/827,224

(22) Filed: Apr. 20, 2004

(51) Int. Cl. B62M 1/00

(52) U.S. Cl. 280/87.041

(57) ABSTRACT

A scooter comprises a plate body; a rear wheel pivotally installed at a rear end of the plate body; a suspending arm installed at a front end of the plate body; a head tube installed at a front end of the suspending arm; a rotary disk installed at a lower end of the head tube; a front wheel installed below the suspending arm and connected to the rotary disk so that the front wheel is rotatable with respect to the rotary disk; the position of the front wheel is shift from the suspending arm. Moreover, in another structure, a linkage is installed transversally at a front end of the suspending arm. Two ends of the linkage are installed with respective two front wheels through respective head tubes and frames so that the front wheels are assembled to the respective rotary disks.

### FIELD OF THE INVENTION

The present invention relates to scooters, and particular to a scooter which can be controlled easily and conveniently.

### BACKGSEMI-ROUND OF THE INVENTION

The prior art scooter has a four wheel. In use, one leg of the user treads upon the scooter and another leg treads on the ground so as to drive the scooter to move forwards. However, the prior art scooter is heavy and large. The direction of the scooter is adjusted by adjusting the gravitational center of the user. To change the direction of the scooter is by the two front wheels. Thereby, the operation of the scooter is not easily and vividly. Moreover, the user uses one leg to tread upon the scooter and another leg treads the ground. If the scooter moves for a long distance, the user will feel tired and the legs and joints of the user have large burdens so that the interest of the user is reduced.

### SUMMARY OF THE INVENTION

Accordingly, the primary object of the present invention is to provide a scooter which can be controlled easily and conveniently.

To achieve above objects, the present invention provides a scooter which comprises a plate body; a rear wheel pivotally installed at a rear end of the plate body; a suspending arm installed at a front end of the plate body; a head tube installed at a front end of the suspending arm; a rotary disk installed at a lower end of the head tube; a front wheel installed below the suspending arm and connected to the rotary disk so that the front wheel is rotatable with respect to the rotary disk; the position of the front wheel is shift from the suspending arm.

Moreover, the present invention provide a scooter comprises a plate body; a rear wheel pivotally installed at a rear end of the plate body; a suspending arm installed at a front end of the plate body; a linkage installed transversally at a front end of the suspending arm; two ends of the linkage being installed with respective head tubes; and each of the head tubes being installed with a rotary disk; two front wheels installed below the two head tubes, respectively, through respective frames so that the front wheels are assembled to the respective rotary disks.

Moreover, in the present invention, a rear end of the plate body is pivotal installed with a wheel cover. A front end of the wheel cover is pivotally installed to the plate body and covers an upper side of the rear wheel, an elastomer is installed between an inner surface of the wheel cover and the plate body for supporting and positioning the wheel cover. The user can tread the wheel cover to press the rear wheel so as to brake the scooter. A rope is used for pulling the wheel cover so that the wheel cover presses the rear wheel to brake the scooter.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is a plane view of the present invention.

FIG. 3 is a schematic view showing the use of the present invention.

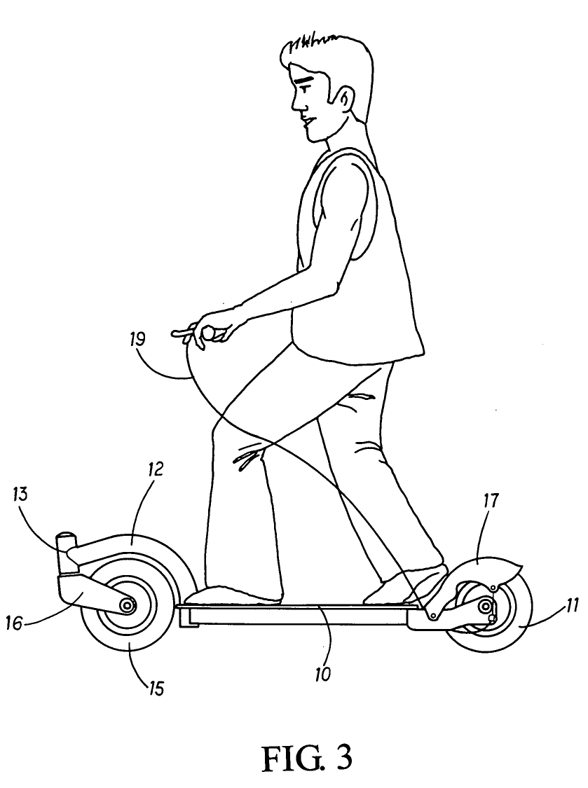

FIG. 4 is a schematic view showing the positioning of the front wheel as the scooter of the present invention moves forwards.

FIG. 5 shows the use of the present invention, where the scooter of the present invention can rotate around a rotary disk as the user twists his or her body.

FIG. 6 shows another embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

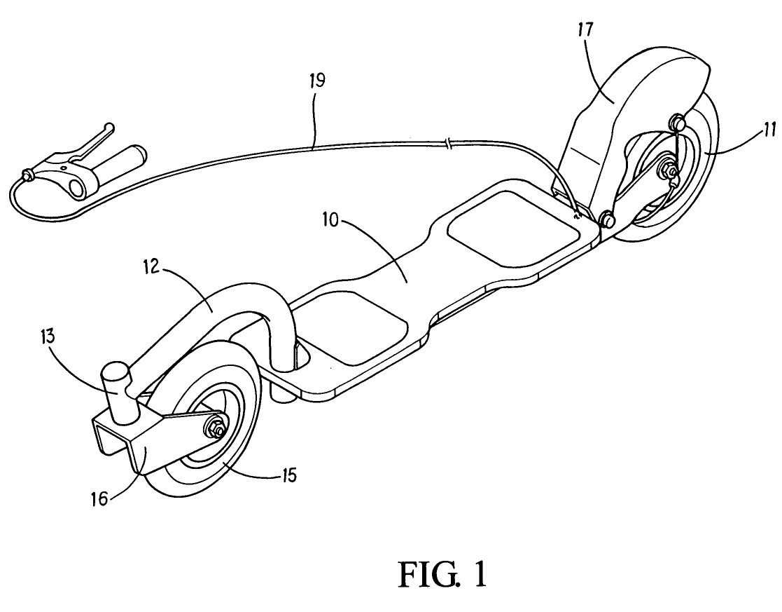

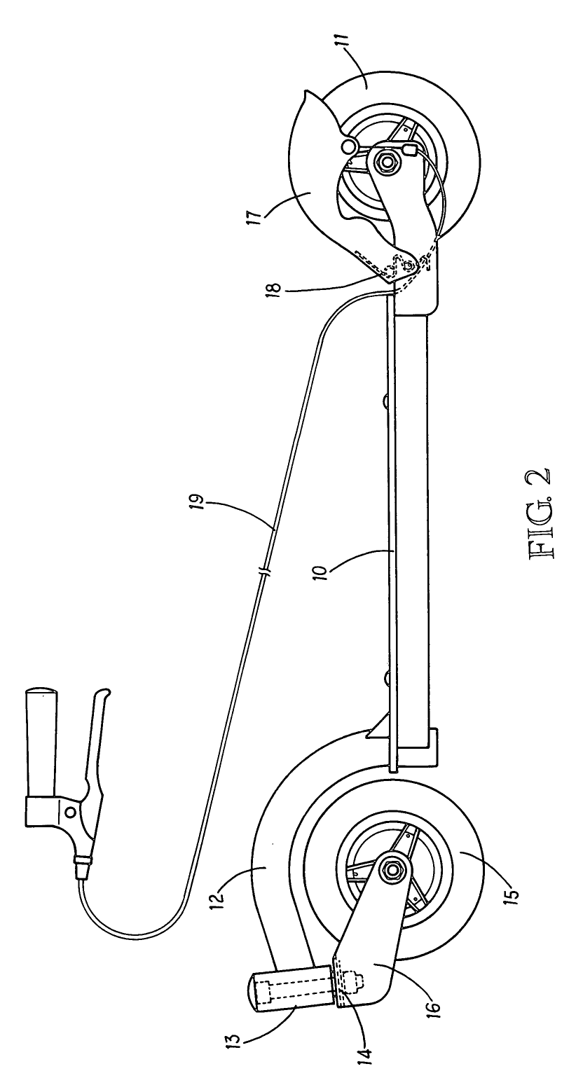

With reference to FIGS. 1 and 2, the scooter of the present invention has a plate body 10. A rear wheel 11 is pivotally installed at a rear end of the plate body 10. A suspending arm 12 is installed at a front end of the plate body 10. A head tube 13 is installed at a front end of the suspending arm 12. A rotary disk 14 is installed at a lower end of the head tube 13. A front wheel 15 is installed below the suspending arm 12, but shift asides. The front wheel 15 is rotatable along the rotary disk 14. The installation of the front wheel 15 has a shift from an axis of the plate body 10. Thereby, the front wheel 15 can be obliquely installed below the suspending arm 12 at a front end of the plate body 10.

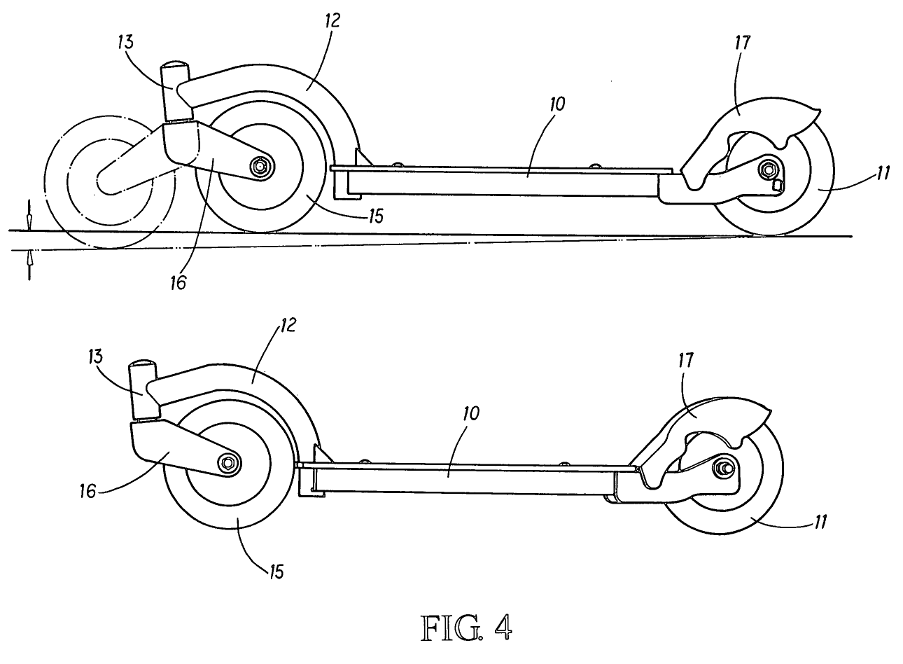

The user can drive the scooter by one leg treading upon the plate body 10 and another leg serves to drive the scooter with an initial speed (referring to FIG. 4). The reason that the present invention provides the functions of steady straight moving and changing direction is that the front wheel 15 is shifted from the lower end of the rotary disk 14. The front wheel 15 is rotatable around the rotary disk 14. When the front wheel 15 is not pressed by the plate body 10, the front wheel 15 can rotate so as to have a farthest and a nearest position with respect to the plate body 10, as shown in FIG. 4. When the user pushes the plate body 10 to move forwards, the front wheel 15 rotates. The friction force and stress connected the front wheel 15 and the ground will cause the front wheel 15 to roll to be retained in positions near the plate body 10. Moreover, one leg of the user treads upon the plate body 10 and presses the front wheel 15. The front wheel 15 is confined not to eject upwards. Moreover, at this position, the front wheel 15 cannot move to the farthest position with respect to the rotary disk 14, see FIG. 4, the position shown by dashed lines. The user can control the direction of the scooter by changing the gravitational center of the user.

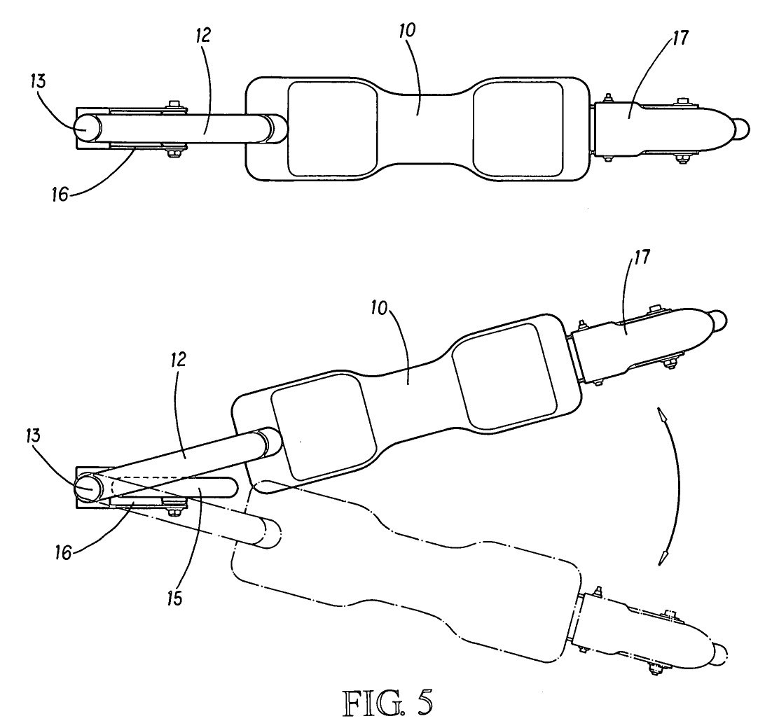

With reference to FIG. 5, in moving, the user can shift his or her body to provide power to the scooter or to accelerate the scooter. Thereby, the plate body 10 can move reciprocally with respect to the rotary disk 14. If the plate body 10 and the rear wheel 11 shift laterally, since at this moment, the plate body 10 and the rear wheel 11 are shifted from the front wheel 15 so that the front wheel 15 is not at the nearest end. At this moment, the weight of the user will press the front wheel 15 so that the front wheel 15 is retained in a correct position. The rear wheel 11 and the plate body 10 will have a clamping effect to the front wheel 15. Thus the front wheel 15 has a torque in moving forwards. Thereby, in operation, the user can swing his or her body so that the plate body 10 moves reciprocally with respect to the rotary disk 14 so as to achieve the effects of acceleration and moving forwards. Thereby, the user's leg is unnecessary to tread the ground continuously.

Furthermore, to have a convenient and safety operation, a rear end of the plate body 10 is pivotal installed with a wheel cover 17. A front end of the wheel cover 17 is pivotally to the plate body 10 and covers an upper side of the rear wheel 11. Furthermore, an elastomer 18 is installed between an inner surface of the wheel cover 17 and the plate body 10 for supporting and positioning the wheel cover 17. By above features, the user can tread the wheel cover 17 or a rope 19 can be used to pull the wheel cover 17 to move downward to press the rear wheel 11 so as to brake the scooter.

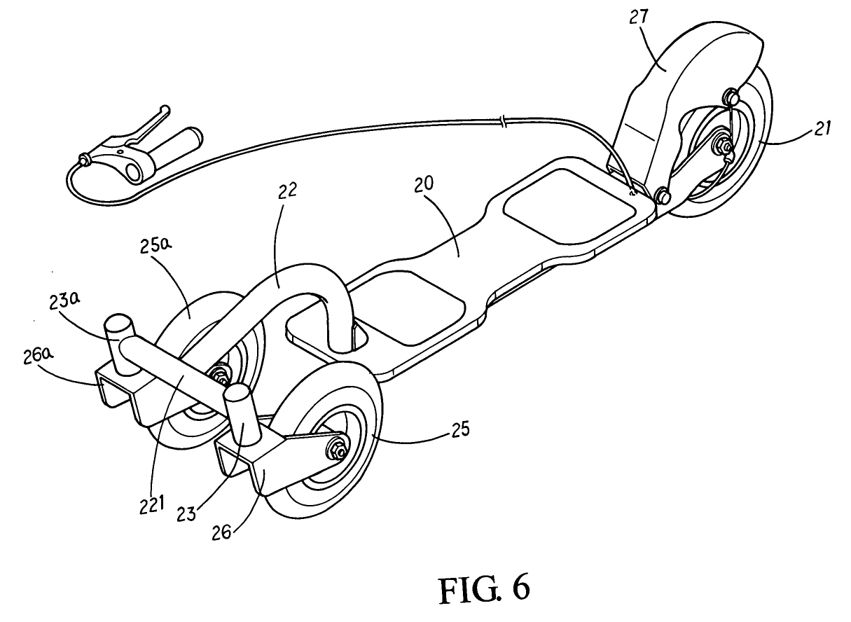

With reference to FIG. 6, a perspective view about another embodiment of the present invention is illustrated. A rear end of the plate body 20 is pivotally installed with a rear wheel 21. A wheel cover 27 covers the upper side of the rear wheel 21. A suspending arm 22 is installed at a front end of the plate body 20. A linkage 221 is installed transversally at a front end of the suspending arm 22. Two ends of the linkage 221 are installed with respective head tubes 23, 23a. Each of the head tubes 23, 23a is installed with a rotary disk (not shown). Two front wheels 25, 25a are installed below the two head tubes 23, 23a, respectively, through the respective frames 26, 26a so that the front wheels 25, 25a are assembled to the respective rotary disks. Thereby, a scooter having three wheels are formed. In operation, the user treads the plate body 20 to move forwards and the user can adjust his or her gravitational center to control the moving direction. Moreover, the user could make the plate body 10 to move reciprocally by twisting the body so as to accelerate the plate body 10. Thereby, the use can study to use the scooter easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1-3. (canceled)

4. A scooter comprising:
a plate body;
a rear wheel pivotally installed at a rear end of the plate body;
a suspending arm installed at a front end of the plate body;
a linkage installed transversally at a front end of the suspending arm; two ends of the linkage being installed with respective head tubes; and each of the head tubes being installed with a rotary disk;
two front wheels installed below the two head tubes, respectively, through respective frames so that the front wheels are assembled to the respective rotary disks.

5. The scooter as claimed in claim 4, wherein a rear end of the plate body is pivotal installed with a wheel cover; a front end of the wheel cover is pivotally installed to the plate body and covers an upper side of the rear wheel, an elastomer is installed between an inner surface of the wheel cover and the plate body for supporting and positioning the wheel cover; wherein a user can tread the wheel cover to press the rear wheel so as to brake the scooter.

6. The scooter as claimed in claim 4, wherein a rear end of the plate body is pivotal installed with a wheel cover; a front end of the wheel cover is pivotally installed to the plate body and covers an upper side of the rear wheel, an elastomer is installed between an inner surface of the wheel cover and the plate body for supporting and positioning the wheel cover; a rope is used for pulling the wheel cover so that the wheel cover presses the rear wheel to brake the scooter.
